(19) United States
(12) Patent Application Publication
(10) Pub. No.: US 2009/0221276 A1
(43) Pub. Date: Sep. 3, 2009

(54) USER INTERFACE FOR CUSTOM RECORDABLE RING TONES

(75) Inventors: Raymond Paul VANDER VEEN, Waterloo (CA); Gerhard Dietrich KLASSEN, Waterloo (CA)

Correspondence Address: PERRY + CURRIER INC.;(FOR RIM), 1300 YONGE STREET, SUITE 500, TORONTO, ON, M4T-1X3, CA

(73) Assignee: RESEARCH IN MOTION LIMITED, Waterloo (CA)

(21) Appl. No.: 12/039,774

(22) Filed: Feb. 29, 2008

(51) Int. Cl. H04M 3/00

(52) U.S. Cl. 455/418

(57) ABSTRACT

An electronic device and a method implemented within the electronic device for displaying a user interface window on the electronic device for associating an audible notification with a specific event; activating a record function from the user interface window for recording an audio file; and saving the audio file as the audible notification associated with the specific event.

### FIELD

The present specification relates to electronic devices, and in particular to a method and user interface for generating event-specific ring tones in an electronic device.

### BACKGROUND

Audible reminders in the form of custom ring tones are well known for notifying a user of events such as an incoming call, appointment or task. It is also known to associate different ring tones with different categories of such events (e.g. a first ring tone for calendar reminders, a second ring tone for incoming calls, a third ring tone for incoming emails, etc.). Moreover, it is also known to use recorded voice samples as ring tones. For example, it is known in the art to record and save custom voice samples in a list of ring tones for association with different categories of events. It will be appreciated that specifying multiple event-specific ring tones can lead to user confusion since a user is only capable of memorizing a finite number of different ring tone associations.

Consequently, it is desirable to provide a mechanism for a user to specify individual electronic device reminders associated with respective events, without requiring the user to look at the device (e.g. the user may be driving a car, in which case it would be dangerous for the user to look at the device in order to see a reminder description of an event). Moreover, it is desirable to provide custom audible alarms for a multiplicity of events without requiring the user to memorize a corresponding multiplicity of associated ring tones.

### BRIEF DESCRIPTION OF THE DRAWINGS

The embodiments will be better understood with reference to the following Figures in which like numerals denote like parts and in which:

FIG. 1 is a simplified block diagram of a wireless communication system;

FIG. 2 is a block diagram of components of a portable electronic device;

FIGS. 3A-3F are screen shot representations of a graphical user interface of the portable electronic device in FIG. 2 for creating and associating an audible reminder for calendar notifications, according to an embodiment;

FIGS. 4A-4E are screen shot representations of a graphical user interface of the portable electronic device in FIG. 2 for creating and associating an audible reminder for a new calendar appointment event, according to an embodiment;

FIGS. 5A and 5B are screen shot representations of a graphical user interface of the portable electronic device in FIG. 2 for associating an audible reminder with an incoming call, according to an embodiment;

FIG. 6, comprising FIGS. 6A and 6B, is a flowchart showing a method of creating and associating an audible reminder for calendar notifications, according to the embodiment of FIGS. 3A-3F; and

FIG. 7, comprising FIGS. 7A and 7B, is a flowchart showing a method of creating and associating an audible reminder for a new calendar appointment, according to the embodiment of FIGS. 4A-4E.

### DETAILED DESCRIPTION

In general, a method and user interface are set forth for associating event-specific audio recordings with specific events on an electronic device, such as a portable phone, smart phone, PDA, etc.

According to one aspect, there is provided a method of operating an electronic device, comprising: displaying a user interface window on said electronic device for associating an audible notification with a specific event; activating a record function from said user interface window for recording an audio file; and saving said audio file as said audible notification associated with said specific event.

According to another aspect, there is provided a user interface for an electronic device, comprising: an input device; a first window display generated responsive to a first input to said input device for associating an audible notification with a specific event on said electronic device; a second window display generated responsive to a second input to said input device for activating a record function to record an audio file; and a third window display generated responsive to a third input to said input device for saving said audio file as said audible notification associated with said specific event.

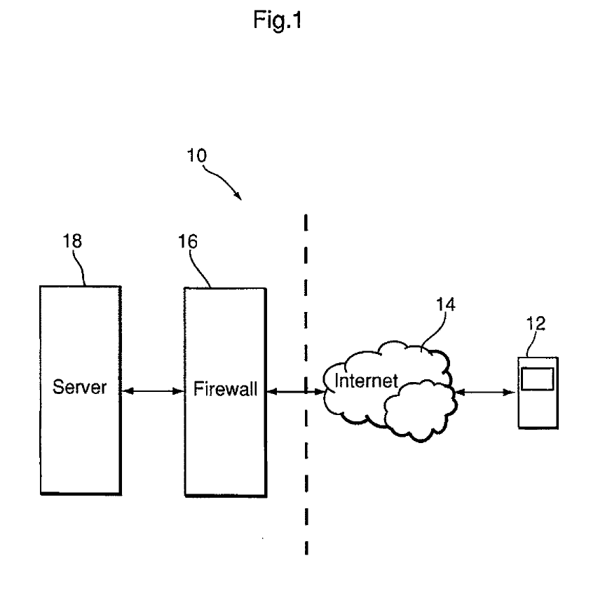

FIG. 1 is a simplified block diagram of an exemplary communication system 10 for a portable electronic device 12. According to the illustrated embodiment, the portable electronic device 12 is operable to effect communications over a radio communications channel and communicates with a base station (not shown) while located within a coverage area that is defined by the base station. However, the portable electronic device 12 is not limited to a device capable of effecting communications. Indeed, the exemplary method of creating and associating audible reminders set forth in greater detail below, may advantageously be implemented within a multitude of devices, some of which are capable of communications and others of which are not (e.g. PDAs, mobile phones, smart telephones, laptop computers, etc.).

In the illustrated embodiment, the base station (not shown) is part of a wireless network that is in communication with the Internet 14. Data is delivered to the portable electronic device 12 via wireless transmission from the base station. Similarly, data is sent from the portable electronic device 12 via wireless transmission to the base station.

It will be appreciated that the portable electronic device 12 of FIG. 1 is movable within a coverage area of the base stations and can be moved to coverage areas defined by other base stations. Further, as will be understood by one of ordinary skill in the art, wireless networks include GSM/GPRS, CDPD, TDMA, iDEN, Mobitex, DataTAC networks, EDGE, EVDO or UMTS and broadband networks such as Bluetooth and variants of 802.11.

A server 18 handles wireless client requests from the portable electronic device 12. A firewall, or proxy server, 16, is provided between the server 18 and the Internet 14. The server 18 further operates as a Mail Server, which communicates with an email client of the portable electronic device 12 to allow a user to send and receive email messages.

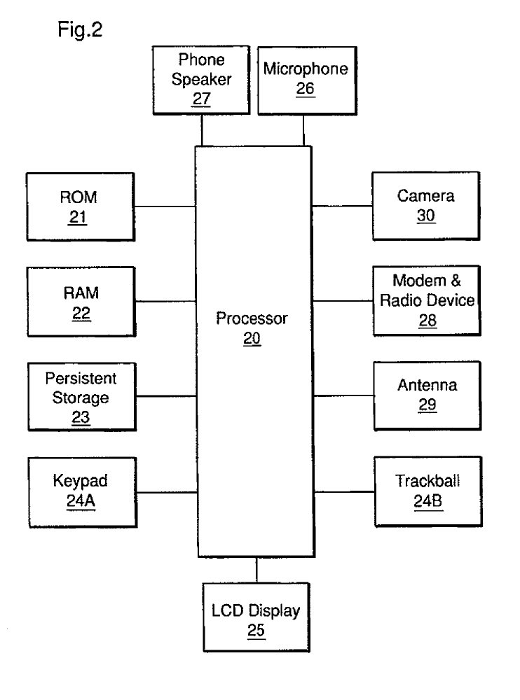

FIG. 2 is a block diagram showing certain components within an exemplary embodiment of the portable electronic device 12. The portable electronic device 12 includes a processor 20 connected to a read-only-memory (ROM) 21 that contains a plurality of applications executable by the processor 20 for enabling each portable electronic device 12 to perform certain functions including, for example, Personal Identification Number (PIN) message functions, Short Message Service (SMS) message functions, address book and calendaring functions, camera functions, and cellular telephone functions. More particularly, processor 20 may execute applications within ROM 21 for notifying the user of events such as incoming call and/or emails, appointments, tasks, etc., as hereinbefore described. The processor 20 is also connected to a random access memory unit (RAM) 22 and a persistent storage device 23 to facilitate various non-volatile storage functions of the portable electronic device 12. The processor 20 receives input from one or more input devices, including a keypad 24A and trackball 24B. The processor 20 outputs to one or more output devices, including a Liquid Crystal Display (LCD) display 25. A microphone 26 and phone speaker 27 are connected to the processor 20 for cellular telephone functions. The processor 20 is also connected to a modem and radio device 28. The modem and radio device 28 is used to connect to wireless networks and transmit and receive voice and data communications through an antenna 29. A camera 30 provides functionality for taking pictures that can be viewed on display 25, sent to other users via wireless email, saved to persistent storage 23 for later viewing, etc.

In the context of this specification and the exemplary embodiment illustrated in the drawings, “user interface” comprises an input device (such as keypad 24A, trackball 24B, etc.) and at least one graphical window displayed via an output device (such as display 25).

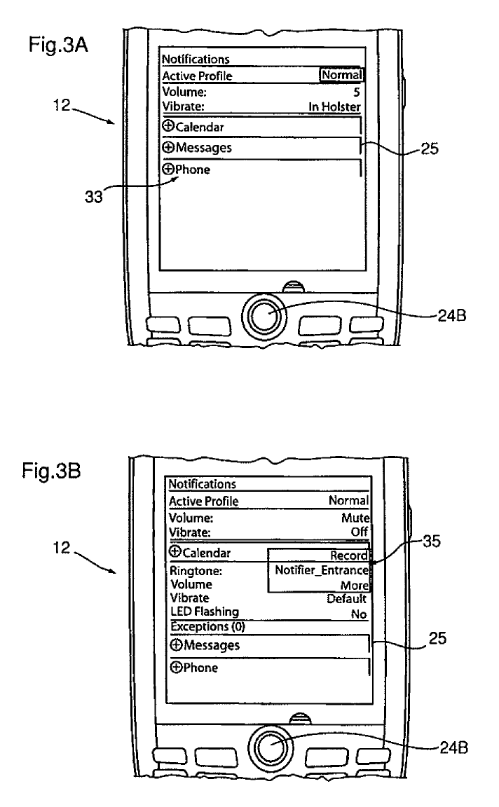

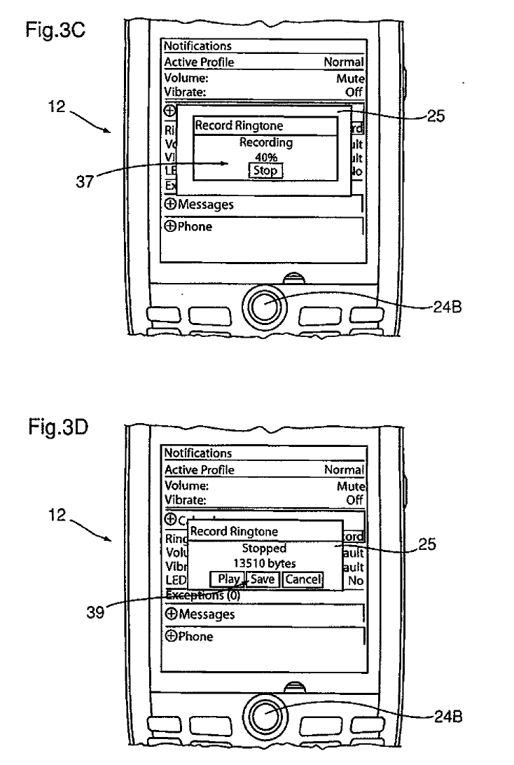

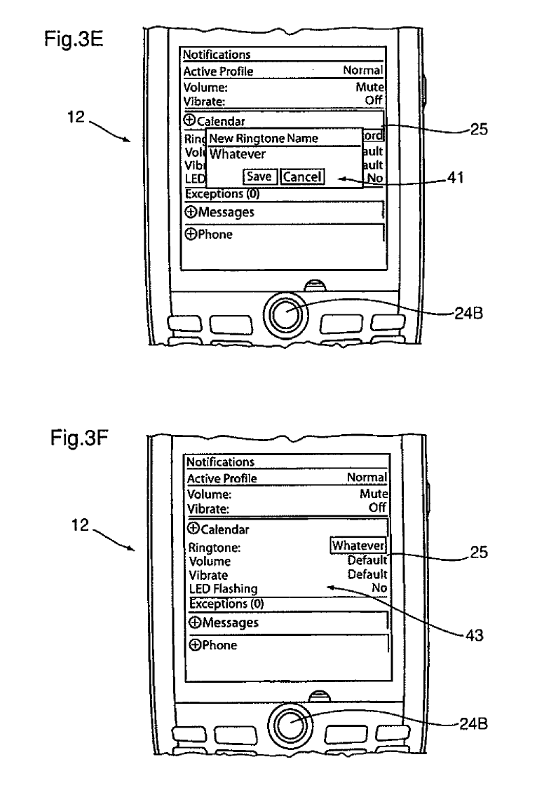

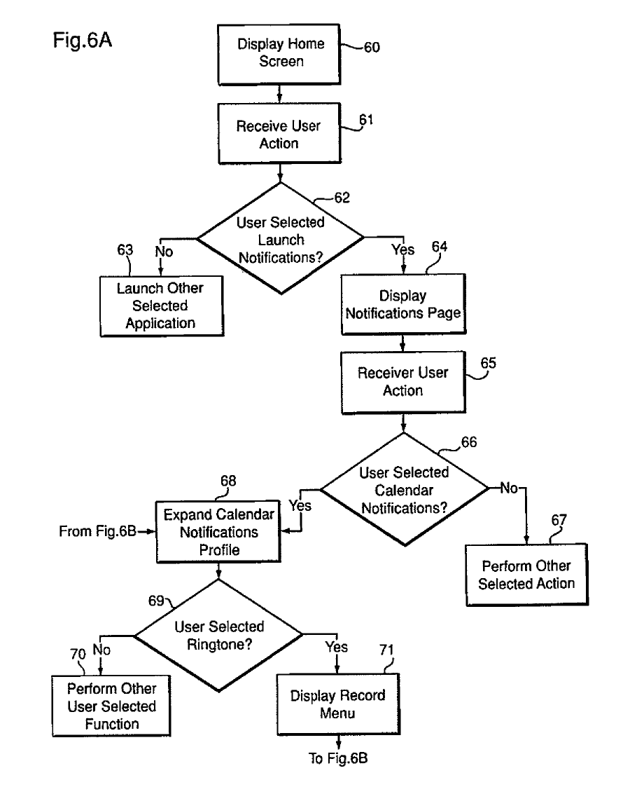

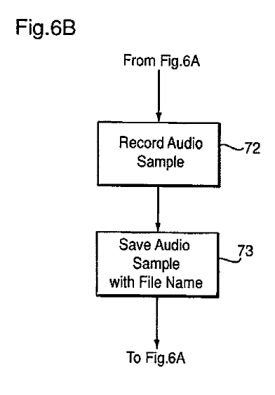

According to a first aspect of this detailed description, as shown in FIGS. 3A-3F and as further depicted in FIGS. 6A and 6B, portable electronic device 12 may be used to create and associate a default audible notification for calendar events.

With reference to FIG. 6A, in an idle or default state for device 12, a home screen window (not shown) is displayed (60) from which a user may launch various applications by selecting associated icons on display 25. Upon making a selection (61), a determination is made (62) as to whether the user has selected to launch a Notifications application. If not, the device 12 launches another application associated with the user selected icon (63). If the user has selected to launch the Notifications application, a window (33) is displayed (64) as shown in FIG. 3A.

From this window, the user may select from among a plurality of device applications (e.g. Calendar, Messages, Phone, etc.) within ROM 21 and executable by processor 20, with which event notifications may be customized. In response to a further user selection (65) a determination is made (66) as to whether the user has selected to expand the Calendar Notifications profile or take some other specified action (67), such as expanding the Messages or Phone profiles, etc.

Once the Calendar Notifications profile has been expanded, the user may select a Ringtone field (a “Yes” at 69) from the expanded profile. In response, as shown in FIG. 3B, a “Record” function is presented (71) from a pop-up menu (35) for selecting an existing ring tone (e.g. “Notifier_Entrance”) or recording a custom audio sample (72) as a notification for all calendar events (FIG. 6B). Otherwise, another selected function is performed (70).

As shown in FIG. 3C, upon completing the recorded audio sample the user may press a “Stop” button via a window (37) and then “Save” the recording with a user selected file name (73) via further windows (39 and 41) as shown in FIGS. 3D and 3E. The display then returns to the expanded Calendar Notifications screen (FIG. 3F), where the audio file name (e.g. “Whatever”) is indicated in the “Ringtone:” field of a window (43).

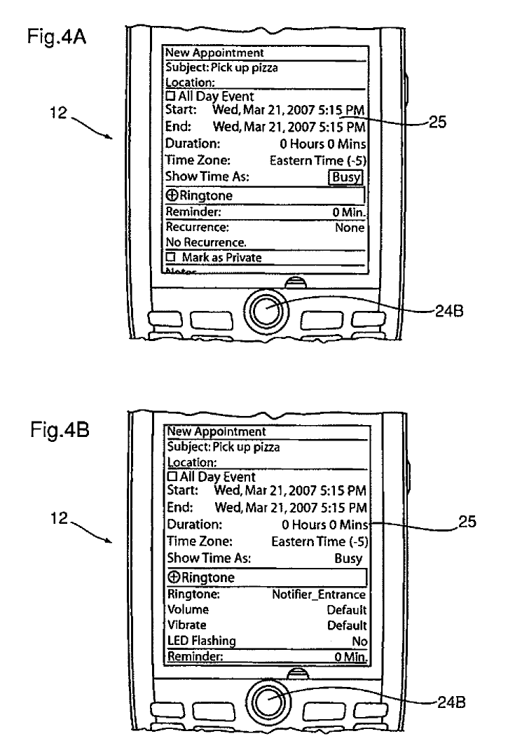

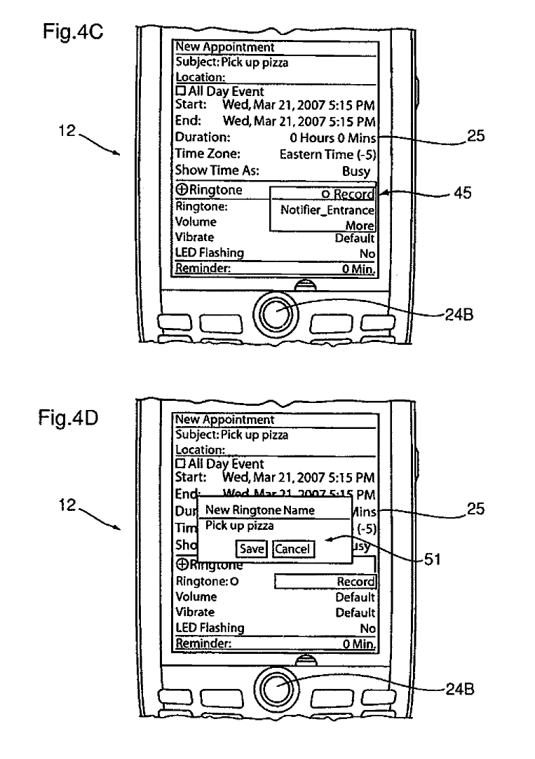

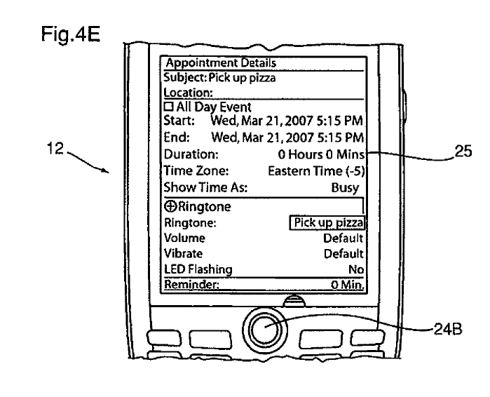

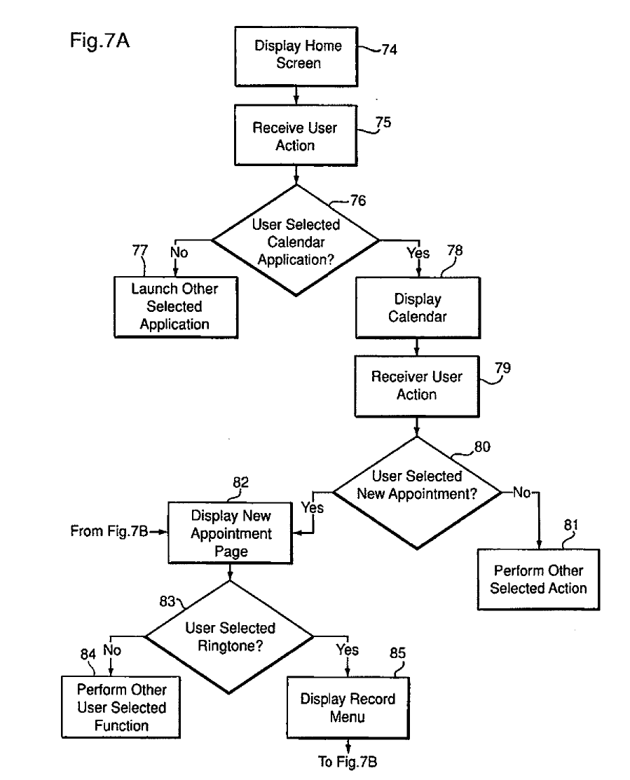

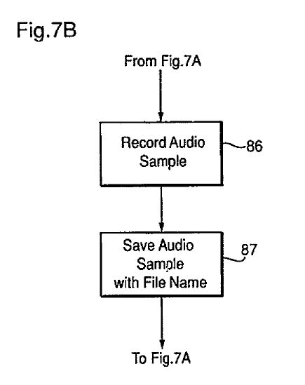

According to a second aspect of this detailed description, as shown in FIGS. 4A-4E and as further depicted in FIGS. 7A and 7B, portable electronic device 12 may also be used to create and associate an audible notification for a specific calendar event notification (e.g. “Pick up pizza” at 5:15 PM on Wed, Mar. 21, 2007), as an alternative, for example, to the default notification discussed above in connection with FIGS. 3A-3F and FIGS. 6A and 6B.

With reference to FIG. 7A, in an idle or default state for device 12, a home screen (not shown) is displayed (74) from which a user may launch various applications by selecting associated icons on display 25. Upon making a selection (75), a determination is made (76) as to whether the user has selected to launch the Calendar application. If not, the device 12 launches another application associated with the user selected icon (77). If the user has selected to launch the Calendar application, a conventional calendar user interface is displayed (not shown), from which the user may select among a plurality of actions (e.g. Open Appointment, New Appointment, etc.) In response to such a user selection (79), a determination is made (80) as to whether the user has selected to make a New Appointment or take some other specified action (81), such as cancelling out of the Calendar application, etc.

In response to user selection to make a New Appointment, the user may expand the Ringtone label (FIG. 4A) resulting in an expanded display (FIG. 4B), as discussed above. From within the expanded display, the user may select a Ringtone field (a “Yes” at 83) of the expanded display in response to which a “Record” function is presented (85) from a pop-up menu window (45), as shown in FIG. 4C, for selecting an existing ring tone (e.g. “Notifier_Entrance”) or recording a custom audio sample (86) as a notification for the new calendar Appointment. For example, the user may record a spoken description of the event, such as “Pick Up Pizza”, using his/her own voice. Otherwise, another selected function is performed (84).

As shown in FIG. 4D, upon completing the recorded audio sample the user may “Save” the recording, with a user selected file name (87), via a further pop-up menu window (51). The display then returns to the expanded Appointment screen (FIG. 4E), where the audio file name is indicated in the “Ringtone:” field and the page header has been updated to “Appointment Details”.

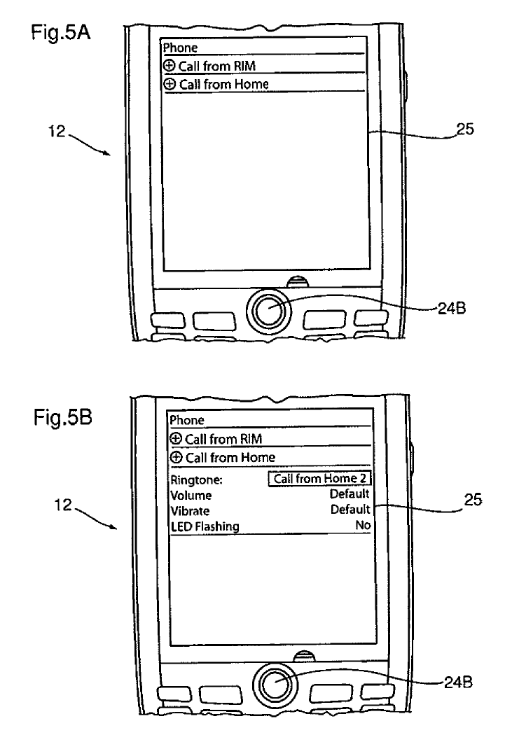

A person of ordinary skill in the art will understand that a plurality of such customized ring tones may be recorded for providing informative notifications of multiple events according to the methodology and exemplary user interfaces set forth above. For example, as shown in FIGS. 5A and 5B, a user may record customized audio samples to be used as notifications for incoming calls from work or from home, based on CLID data associated with the incoming calls. In FIG. 5B, a custom ring tone is identified by the file name “Call from Home 2” which can, for example, be an audio sample of the user, announcing “Call from home”, or an audio sample of a party associated with the event, such as the user's spouse or partner, announcing “Honey, its me!”. Likewise, an email from an important client may be identified by a custom ring tone in the user's voice, such as “Email from Bob at XYZ Co.”

Specific embodiments have been shown and described herein. However, modifications and variations may occur to those skilled in the art. For example, as discussed above, although the exemplary embodiment has been described in terms of implementation on a portable handheld electronic device, the principles set forth herein may be applied to other devices such as desktop computers, etc. All such modifications and variations are believed to be within the sphere and scope of the present embodiment.

What is claimed is:

1. A user interface for an electronic device, comprising:
an input device;
a first window display generated responsive to a first input to said input device for associating an audible notification with a specific event on said electronic device, said specific event being selected from the group consisting of a calendar appointment, an incoming call, an incoming email, and a task;
a second window display generated subsequent to said first window display and responsive to a second input to said input device for activating a record function to record an audio file; and
a third window display generated subsequent to said second window display and responsive to a third input to said input device for saving said audio file as said audible notification associated with said specific event.

2. A user interface as claimed in claim 1, wherein said audio file is a spoken description of said specific event.

3. A user interface as claimed in claim 2, wherein said spoken description is recorded by a user of said electronic device.

4. A user interface as claimed in claim 2, wherein said spoken description is recorded by a party associated with said specific event.

5. A user interface as claimed in claim 3, wherein said audio file is saved as a ring tone on said electronic device.

6. A user interface as claimed in claim 4, wherein said audio file is saved as a ring tone on said electronic device.

7. A method of operating an electronic device, comprising:
displaying a user interface window on said electronic device for associating an audible notification with a specific event;
activating a record function from said user interface window for recording an audio file; and
saving said audio file as said audible notification associated with said specific event.

8. A method as claimed in claim 7, wherein said specific event is a calendar appointment.

9. A method as claimed in claim 7, wherein said specific event is an incoming call.

10. A method as claimed in claim 7, wherein said specific event is an incoming email.

11. A method as claimed in claim 7, wherein said specific event is a task.

12. A method as claimed in claim 7, wherein said audio file is a spoken description of said specific event.

13. A method as claimed in claim 12, wherein said spoken description is recorded by a user of said electronic device.

14. A method as claimed in claim 12, wherein said spoken description is recorded by a party associated with said specific event.

15. A method as claimed in claim 7, wherein said audio file is saved as a ring tone on said electronic device.

16. A user interface for an electronic device, comprising:
an input device;
a first window display generated responsive to a first input to said input device for associating an audible notification with a specific event on said electronic device;
a second window display generated responsive to a second input to said input device for activating a record function to record an audio file; and
a third window display generated responsive to a third input to said input device for saving said audio file as said audible notification associated with said specific event.

17. A user interface as claimed in claim 16, wherein said specific event is a calendar appointment.

18. A user interface as claimed in claim 16, wherein said specific event is an incoming call.

19. A user interface as claimed in claim 16, wherein said specific event is an incoming email.

20. A user interface as claimed in claim 16, wherein said specific event is a task.

21. A user interface as claimed in claim 16, wherein said audio file is a spoken description of said specific event.

22. A user interface as claimed in claim 21, wherein said spoken description is recorded by a user of said electronic device.

23. A user interface as claimed in claim 21, wherein said spoken description is recorded by a party associated with said specific event.

24. A user interface as claimed in claim 16, wherein said audio file is saved as a ring tone on said electronic device.
